(19) United States
(12) Patent Application Publication
(10) Pub. No.: US 2007/0050305 A1
(43) Pub. Date: Mar. 1, 2007

(54) RFID system for predictive product purchase date evaluation

(76) Inventor: Elliot Klein, New York, NY (US)

Correspondence Address: COZEN O'CONNOR, P.C., 1900 MARKET STREET, PHILADELPHIA, PA, 19103-3508, US

(21) Appl. No.: 11/306,594

(22) Filed: Jan. 4, 2006

Related U.S. Application Data
(60) Provisional application No. 60/596,028, filed on Aug. 25, 2005.

(51) Int. Cl. G06Q 99/00

(52) U.S. Cl. 705/67

(57) ABSTRACT

Operating parameters and potentially related event dates are gathered from end users of computer systems and fed into a predictive model to generate post-sale predictions of purchase date when a product is presented from end users and fed into the prediction model. Products may be accepted for service, repair, return, and exchange based on predictions of purchase date reported by the system with an associated confidence level.

### RELATED APPLICATION DATA

The present application claims priority based on U.S. Provisional Patent Application Ser. No. 60/596,028 filed on Aug. 25, 2005.

### FIELD OF THE INVENTION

A computerized system for sellers, manufactures and customer service centers to apply historical data to predicatively estimate when an item was first purchased or placed in use. The system reduces second-guessing of in-use product purchase dates by identifying patterns from aggregated shipping and receiving event data recorded within the Electronic Product Code (“EPC”) Network to estimate an item's in-use or purchase date when a purchase receipt or other specific purchase date record is not readily available.

### BACKGROUND OF THE INVENTION

The invention describes a computerized method for predictive-analytics that evaluates Electronic Product Code (“EPC”) data to estimate purchase date of an item using data gathered from end users by Electronic Product Codes (“EPC”)

Definition List 1

| Term | Definition |
|---|---|
| Electronic Product | Electronic Product Code ™ (EPC) is a simple, |
| Code (“EPC”) | compact “license plate” that uniquely |
| | identifies objects (items, cases, pallets, |
| | locations, etc.) in the supply chain with a |
| | Radio-frequency identification (“RIFD”) tags. |

and other historical operating parameters that are recorded, fed and linked by an RFID identifier data within the EPCglobal™ Network.

Definition List 2

| Term | Definition |
|---|---|
| EPCglobal Network | The EPCglobal Network is a set of technologies |
| | that enable immediate, automatic identification |
| | and sharing of information on items in the |
| | supply chain by enabling true visibility of |
| | information about items in the supply chain. |

The invention improves supply chain efficiencies associated with individual products, shipping pallets, and cartons to better predict a product's purchase date. Such information is useful to sellers, manufacturers or service centers whenever a purchase date record is not available by store cash register record or customer purchase receipt because a customer generally has a finite number of days post-purchase, after which a customer may not be entitled to return an item for credit, repair or replacement.

The EPCglobal Network uses radio frequency identification (RFID) technology to enable true visibility of information about items in the supply chain. The EPCglobal Network is comprised of five fundamental elements: the Electronic Product Code (EPC), the ID System (EPC Tags and Readers), Object Name Service (ONS), Physical Markup Language (PML), and Savant.

Essentially, the EPC is a number designed to uniquely identify a specific item in the supply chain. The EPC number sits on a tag comprised of a silicon chip and an antenna, which is attached to an item. Using radio identification technology (RFID), a tag “communicates” its number to a reader.

Like many current numbering schemes used in commerce, the EPC is divided into numbers that identify the manufacturer and product type. But, the EPC uses an extra set of digits unique to the EPCglobal Network to identify unique items. The EPC is the key to the information about the product it identifies that exists in the EPCglobal Network. An EPC number is typically reported in a format similar to EPC identifier represented by an Internet accessible data string such as “urn:epc:id:sgtin:610083.244.271” and includes a:
(1) Header, which identifies the length, type, structure, version and generation of EPC Manager Number, that identifies the company or company entity;
(2) Object Class, providing information on the specific type or product model, and
(3) Unique EPC ID Number, which is the specific instance of the Object Class being tagged.

Additional fields may also be used as part of the EPC in order to properly encode and decode information from different numbering systems into their native (human-readable) forms that are integrated as data inputs into the instant inventive RFID system for predictive product location events and related purchase date evaluation.

The ability to accurately model and predict in-use or purchase date in a product's lifecycle (i.e., once goods have been shipped or sold at retail store or by ecommerce to customers) is very desirable, especially to prevent return fraud and improve post-sale customer service.

Such predictive analytic system and software provides correlations to estimate a specific date of purchase as a tool for customer service representatives at retail stores, repair depots, and other customer service locations to estimate date of purchase of products purchased from specific selling location(s), or moving through the supply chain, by reading an EPC/RFID tag associated with the sold product(s) and linked to the EPCglobal Network.

Specifically, application of predictive product purchase date automation analysis with Electronic Product Code (“EPC”) and RFID tag event solutions, with a Web-based interface solution, improves upon prior art by improving post-sale customer service to better manage product return acceptance based on predictive decision-making systems without the requirement for presentment of a dated customer receipt that is often discarded or otherwise misplaced by a customer.

### SUMMARY OF THE BACKGROUND ART

Known systems and methods for returning of products include the use of radio frequency identification tags (RFID tags) having stored therein identifying information which may be read and used to authenticate and verify the specific owner of a product to which the RFID tag is affixed. One such system and method is disclosed in Applicant's U.S. Pat. No. 6,965,866 entitled “Product warranty registration system and method” that includes an interrogatable tag such as an RFID tag attached to an item. The invention describes a visible label with an ID number and printed instruction to return product to an express courier location (i.e., FedEx, UPS, USPS) for return processing through the express courier's shipping network. The disclosed system and method is useful for authenticating and verifying items at a courier shipping location only if they have been individually pre-registered for access by a courier service to return products should they become lost or require warranty service through an express courier's return shipping service. Such system is void of predictive analytic capabilities and only provides customer benefit if a product is specifically registered by the purchaser in tandem with warranty registration for a specific product.

A similar system for providing product authentication by way of identification and courier return is disclosed in Applicant's U.S. Pat. No. 6,259,367 entitled “Lost and found system and method”. The disclosed system relates to RFID tagged items tagged by their owners to provide “lost and found” systems and methods. The disclosed system is useful for returning specific items pre-registered by the owner without predictive analytic capabilities.

As can be seen, there is a need in the art for a system and method for authenticating and validating products which utilize predictive analytic based product purchase date identification methods, instead of specific item or product registration, tied to known purchased products, registered by a retail store or end customer. These new methods differ from prior art, in part, because they instead rely on a parent-child relationship between individual child units contained in a parent pallet or box container to be applied to predict the date of purchase of each individual child unit. Such a system and method preferably provides for predictive estimation of purchase date(s) in an EPCglobal computer system and EPC Network connected customer service environment such as those that can be accessed or located in a Web-based Customer Service department within a retail store.

Other background patent documents from third parties include U.S. Pat. No. 5,978,774 (e.g., verifying printed barcodes, serial number or printed UPC symbols); Application 2002/0188561 (e.g., digital receipt stored in a database for a specific product); U.S. Pat. Nos. 6,543,683 and 6,843,415 (e.g., electronic digital receipts for electronic verification), U.S. Pat. No. 6,901,304 and Application 2005/0131763 (e.g., item and event tracking systems), Application 2005/0273349 and Application 2005/0283635 (e.g., computer system for predictive analysis).

The prior art made of record can often provide effective solutions to verify a date of purchase and related transactional event(s) whenever a printed receipt or other product-specific purchase record (i.e., digital receipt) is readily available for look up on a computer searchable in-store product purchase electronic database or transactional record keeping terminal or system. However, the prior art does not teach the instant inventive methods of predictive analytic systems and methods that are to be used whenever a physical printed proof of purchase or other electronic database record is unavailable for physical presentation by a customer for purchase date event verification and/or computerized electronic look up search at a retail store, repair or product exchange location. This limitation is part of the boundary of the scope of the claimed instant invention. The invention further points out in active/passive method steps a method to carry out the scope of the invention and distinctively claims the subject matter that the applicant regards as the invention.

### BRIEF DESCRIPTION OF THE INVENTION

The statistical analytic system combines the reach and power of predictive product purchase date analytics combined with item-level Electronic Product Code (“EPC”) and the EPCglobal Network. It enhances data validation without a receipt, provides easier and more powerful post-purchase return authorization, and better post-sale customer support. Unlike prior art, these applications mix Electronic Product Code (“EPC”) with aggregated transactional and shipping data to provide location and purchase date event identification data that is not limited to a specific product or item. The methods allow for predictive analysis of similar items, not only the specific or exact item, presented to a computer system to help establish likely purchase date(s) and related event location data that may be required to authorize acceptance of a product return when a receipt or other computerized item-specific record is unavailable for presentment or local store lookup.

These same RFID applications combine electronic-product-code data with transactional shipping data with other date or historical location tracking data to estimate consumer purchase date. Many returns are presented back to retail stores, direct retailers and manufacturers without a receipt or reliable proof of purchase. These channels have the option of saying yes or no to the return. Now with EPC and the networked supply chain environment, companies can scan an RFID tag into a server-based computer system with a quarry over the Internet, and the server can respond with an estimated date of consumer purchase with an associated confidence level specifying the reliability and statistical confidence level the estimate. For example, the server might respond that a RFID/EPC scanned item was sold between Sep. 2, 2005 and Sep. 7, 2005 with a ninety percent confidence level in the reported date range(s).

This predictive application uses supply chain event driven data, including Radio Frequency Identification (“RFID”) data, to estimate an RFID tagged product's purchase date. The benefit associated with this type of technology is that it manages return fraud and helps eliminate the requirement for the customer presentment of a printed receipt proof of purchase receipt in a customer service environment.

RFID technology and labeling brings far more granular data from multiple sources to be used for this purpose than the existing art of digital receipt or other proofs of purchase date when the customer has no receipt when making a product return or other return related warranty or repair claim. More granular event data in the EPC/RFID environment, will often allow the item's seller to better predict the customer's date of purchase. Such data is important to determine if a return item meets the seller's return period for products (i.e., return to store within 7-days with receipt for credit) or a manufacturer's acceptance of a warranty service or related return for repair request (i.e., product covered by one year parts and labor warranty with proof of purchase).

Return entitlement at retail has traditionally been based on the clerk's mood of the day, the physical condition of the product and if the customer has reliable proof of purchase, generally in the form of an original and itemized receipt. The reality is many customers don't save or misplace their original purchase receipt and therefore encounter difficulties with returns to sellers and/or returns to manufacturers for product repairs or returns.

The inventive solution provides the ability to take a partial set of event data, to be able to identify the right event data, and from that limited set, significantly improve forecasting accuracy. Through our inventive science, we are able to find the right pieces of data out of the vast stream of event data that is occurring every day and use that to drive towards predictive analytics for customer purchase or in-use date of a product or associated part within a sold or shipped product.

These instant predictive solutions combine EPC data with transactional operations data that combine RFID and non-RFID environments by augmenting today's best date of purchase signals, such as POS and logistics data, with RFID tag read events recorded and accessible through the EPCglobal Network.

The invention utilizes shipment and inventory movement information by RFID and EPC methods as analytic signals to provide proactive and actionable intelligence and analytics. It enables rapid, accurate responses to product purchase date, or service part repair or replacement request events by end-customers and can complement and integrate with existing EDI store planning, point of sale retail cash register terminals and RFID planning solutions.

Similarly, the inventive product purchase date analytic model component integrates purchase data with key EPC customer, product, manufacturing, inventory, shipping event and date of purchase information across multiple platforms and point of sale captured event data, so manufactures and retail product sellers can achieve a heretofore depth of knowledge and instant analytic level that enables them to make informed, timely decisions even down to the pallet or lot shipment level.

In general, in-store return service presents proactive opportunities to identify issues, differentiate a company through exceptional customer service, build customer loyalty, and enhance brand reputation and lifetime value from each customer relationship. To produce these results, the inventive model analyzes the synchronized EPC supply chain data that is collected from purchase date analysis to present a numerical score that provides a predictive system for manufactures, sellers and repair services to take action to enhance the customer service experience.

### SUMMARY OF THE INVENTION

This specification describes methods and apparatus, including computer program products, for a business intelligence categorization system that reduces the time it takes for product sellers, product manufactures and their distributors to identify and proactively determine or address product returns for products sold at a retail store or shipped to customers.

The word ‘item’ is used in this specification to refer to a real, tangible, object or part, so as to avoid ambiguity from use of the word ‘object’, which will in the following text be used only to refer to a data processing construct. In this context, the term ‘item’ includes a product, packaging carton or shipping pallet.

The word “Web-based” is used in this specification to refer to Internet based access to various computer servers and interaction with Internet browser programs such as those provided by Microsoft Internet Explorer browser by online or LAN connection methods.

The invention features systems and methods, and components configured to perform aspects of the methods, for tracking items. A system in accordance with the invention includes a tagging component that includes information specifying standards for tagging one or more items with tags, each tag including a globally unique EPC Network identifier; an object interface component that includes devices for communicating with the EPC/RIFD tags and that further includes devices for receiving context information; a context-aware intelligence that includes logic for processing context information and logic specifying actions for the system to communicating with devices external to the system.

In general, in another aspect, the invention features systems and methods that performs the actions of receiving multiple instances of EPC/RIFD tag-read-data, each instance including information read from a tag bound to an item, the information read including a unique identifier read automatically from the tag, each instance also including status information including a location of the corresponding tag and its bound item when the unique identifier was read from the tag, the multiple instances of tag-read-data collectively including information read from tags bound to multiple items; receiving one or more instances of context information, each instance describing an associated non-taggable physical circumstance, the context information indicating a status including a location of the circumstance, the multiple instances of context information collectively including information describing multiple circumstances; using the received tag-read-data and context information to maintain on-sale date, end-consumer purchase date and related data circumstances for an item and for each of the multiple items and the pallet level shipment in circumstances including an object for each of the multiple circumstances, each of the objects representing the status of its corresponding item or circumstance; and detecting interactions occurring in the item return event and point of sale purchase data between the circumstances and RFID tag read events.

In general, in another aspect, the invention features systems and methods, and components configured to perform aspects of the methods, for making information available between enterprises.

A method in accordance with this aspect performs the actions of receiving from a first enterprise multiple instances of tag-read-data, each instance including information read automatically from a tag bound to an item including at least a unique EPC/RFID identifier, each instance also including status information including a location of the corresponding tag and its bound item, the multiple instances of tag-read-data received from the first enterprise collectively including information read from tags bound to first multiple items, the tag-read-data including data derived from a first data processing system of the first enterprise; using the tag-read-data received from the first enterprise to maintain a database record in an EPCglobal Network, the database including a representative date and location for each one of the multiple items, each database representing the status of its corresponding item; receiving from a second enterprise multiple instances of second tag-read-data, each instance including information read automatically from a tag bound to an item including at least a unique identifier, each instance also including status information including a location of the corresponding tag and its bound item, the multiple instances of tag-read-data received from the second enterprise collectively including information read from a tag bound to at least one of the first multiple items, the tag-read-data received from the second enterprise including data derived from a second data processing system of the second enterprise; using the tag-read-data received from the second enterprise to maintain associations in the EPCglobal Network environment, the database associations including a statistical correlation for each of the second multiple items, each a association representative representing the status of its corresponding item, where tag-read-data received from either enterprise for a particular item is used to update the virtual association corresponding to the item; and making available the Web-based access information from updated associated representatives and from the EPC/RFID tag or EPCglobal Network to both the first enterprise and the second enterprise.

In general, in another aspect, the invention features methods and apparatus, including computer program products, for providing multiple enterprises real-time and/or historical access to information about specific and similar aggregated items in a supply chain. Tags bound to items are read and information read from the tags and location information about the tags is provided by at least two enterprises and used to maintain disposition information about the items, which is made visible to enterprises in the supply chain.

The tags can be radio-frequency identification tags having each having an EPC (Electronic Product Code) as unique tag identifier. Visibility of the disposition information can be controlled through authorization and access through the EPCglobal Network. Data model information can include relationships between particular items and business documents such as purchase order and shipping documents. With shipping documents visible (i.e., FedEx or parcel truck shipments), information read from item tags can be used to confirm the identity or completeness of a shipment whenever an EPC identification tag is not included on an item. This optional data system can be utilized for data input in the event an EPC tag is not present on an item in accordance with the invention that includes means for receiving from a first enterprise multiple instances of tag-read-data, each instance including information read from a tag bound to an item, the information read including a unique tag identifier read automatically from the tag, each instance also including a location of the corresponding tag and its bound item when the tag identifier was read from the tag, the multiple instances of tag-read-data received from the first enterprise collectively including information read from tags bound to multiple items; means for using the tag-read-data received from the first enterprise to maintain disposition information for the items; means for receiving from a second enterprise multiple instances of second tag-read-data, each instance including information read from a tag bound to an item, the information read including a unique tag identifier read automatically from the tag, each instance also including a location of the corresponding tag and its bound item when the tag identifier was read from the tag, the multiple instances of tag-read-data received from the second enterprise collectively including information read from tags bound to at least one of the multiple items; means for using the tag-read-data received from the second enterprise to maintain disposition information for the items, where tag-read-data received from either enterprise for a particular item is used to update the disposition information; and means for making the disposition information visible to the multiple enterprises in the supply chain, including the first and second enterprises.

Advantageous implementations of the system can include additional features. The system can include means for receiving from a third enterprise multiple instances of third tag-read-data, each instance including information read from a tag bound to an item, the information read including a unique tag identifier read automatically from the tag, each instance also including a location of the corresponding tag and its bound item when the tag identifier was read from the tag, the multiple instances of tag-read-data received from the third enterprise collectively including information read from tags bound to at least one of the multiple items; and means for using the tag-read-data received from the third enterprise to maintain disposition information for the items, where tag-read-data received from any enterprise for a particular item is used to update the disposition information.

The system can be implemented so that the tags bound to the multiple items include radio frequency identification (RFID) tags, each RFID tag carrying an electronic product code (“EPC”) as the unique tag identifier. The system can be implemented so that the visibility is controlled visibility; and the system further includes means for receiving authorization information indicating the extent to which the disposition information should be made visible to a particular enterprise within the supply chain; and means for making visible to the particular enterprise only the disposition information which is permitted by the authorization information.

The system can be implemented so that the disposition information includes a plurality of item attributes; and the authorization information specifies, for at least one of the item attributes, the enterprises to which the item attribute can be made visible. The system can be implemented so that the multiple enterprises include a source enterprise and a destination enterprise; the source enterprise has an order document for an order placed by the destination enterprise and a shipping document for a physical shipment of goods prepared to satisfy the order placed by the destination enterprise; visibility includes visibility of relationships between the tag-read-data and business documents including the order document and the shipping document; and means for providing the enterprises with historical visibility of the disposition of items further to include means for receiving shipping information including the following: EPC/RFID tag identifiers for items corresponding to goods in the shipment; information associating each tag identifier with a shipment number for the shipping document, and information associating the shipment number with an order number for the order document; means for correlating the tag-read-data with the shipping information; and means for making the correlations available to the destination enterprise such that the destination enterprise can use a tag identifier for an item in the shipment to confirm the shipment.

In general, in another aspect, the invention features methods and apparatus, including computer program products, for communicating between nodes of a distributed system that tracks items. The system includes a node hierarchy at a first enterprise, the node hierarchy including one or more parent nodes and one or more local nodes, each local node being a child of a parent node; and a node hierarchy at a second enterprise, the node hierarchy including one or more parent nodes and one or more local nodes, each local node being a child of a parent node. Within the system, each node maintains a mapping between a plurality of items and responsible nodes. The mapping specifies for each item, at least one parent node that is a designated responsible node for the item and for at least two items, different designated responsible nodes. Each node is operable to receive multiple instances of EPC/RFID tag-read-data, each instance including information read from a tag bound to an item, the information read including a unique tag identifier read automatically from the tag, each instance also including a location of the corresponding tag and its bound item when the tag identifier was read from the tag, the multiple instances of tag-read-data collectively including information read from multiple tags bound to multiple items; and for each instance of tag-read-data. Each node is operable to communicate the tag-read-data to the designated responsible node as specified by the mapping maintained by the node.

Advantageous implementations of the system can include additional features. The system can be implemented so that the mapping established at a first node differs from the mapping established at a second node. The system can be implemented so that after tag-read-data is communicated from a node to the designated responsible node for the item, the node receives additional information about the item from the designated responsible node and updates disposition information for the item to reflect the received additional information. The multiple items for which tag-read-data is received can have a hierarchical relationship with each other. The tag identifier can specify a manufacturer or product class (i.e., Sony PlayStation) of the item.

The system includes a monitoring system, one or more subscribers, including a system that tracks tagged items, and one or more event databases. The monitoring system is operable to detect one or more of the tagged items, generate an event, the event including a tag identifier, a reader identifier, and a date and location record associated with the EPC/RFID identifier read by a reader identifier, and publish the event to one or more of the event databases. The system for tracking tagged items is operable to subscribe to receive from one or more of the EPC tag reading events relating to one or more of the tagged items, and upon receiving events, use the received events to update disposition information for one or more of the tagged items. Each event database is operable to maintain a list of subscribers, receive events from the monitoring system, and send events to the subscribers.

In general, in another aspect, the invention features methods and apparatus, including computer program products, for data transfer between distribution locations and in-store point of sale cash register terminals. A computer program product in accordance with this invention is operable to cause data processing apparatus to receive a set of rules, the rules specifying what data to furnish to an external application; receive item data including item identifiers from one or more tag readers, each item identifier being read from a digital tag bound to a physical item, the item identifier uniquely identifying the item; receive additional item data from other sensor devices, the other sensor devices being devices other than tag readers, the additional item data containing additional physical item attributes besides an item identifier, the additional item data being related to one or more items identified by the tag readers; use the rules, item identifiers, and additional item data to determine which subset of the item identifiers and additional item data to furnish to the external application; and furnish to the external application data consisting of only the subset of the received item identifiers and additional item data. The computer program product is further operable to receive data from the external application; the data including customer purchase date associated with shipping and retail on-sale/on-shelf inventory information data sources.

In general, in another aspect, the invention features systems and methods for filtering tracking information. The methods include retrieving a plurality of identification codes associated with a plurality of virtual items, the virtual items including items and containers of items, each identification code being a string of characters that uniquely identify the associated virtual item; locating a character within each identification code that indicates whether the associated object is an item, a container or pallet; and based on the located character, determining whether each identification code corresponds to an item, container or pallet.

Advantageous implementations can have one or more of the following features. The information in the physical world about the items and circumstances is mapped to time, location, and unique identity, whereby the items and circumstances can be tracked relative to each other. The method also derives a prediction from the physical world of at least one of the items based on the purchase and associated event data of the locations of items (e.g., delivery truck shipment history or item/product receipt at distribution warehouse).

Using the more granular forecasts created by EPCglobal and related RFID tracked, shipped and sold items, whose behavior has a high correlation with particular purchase date, can extend the predictive capabilities of the analytic software system and solution.

### BRIEF DESCRIPTION OF THE DRAWINGS

To accomplish this, a unique RFID architecture pulls extended supply chain data into a predictive analytic model for product purchase date decision-making. The invention offers solutions to take advantage of new RFID supply chain data using Electronic Product Codes (“EPC” tag solutions from EPCglobal and others) as illustrated in the drawings that demonstrative the invention with Web-based predictive-analytics software screen and display descriptions attached.

FIG. 1 is a diagram of the EPC Network System;

FIG. 2 is a block diagram of the present architecture;

FIG. 3 is a flow chart of the present method;

FIG. 4 is a Web-based interface example to enter a post-purchase item EPC number;

FIG. 5 is a Web-based screen interface example showing a user computer system connecting to the EPC-IS of the EPC Network; and

FIG. 6 is a Web-based screen interface displaying the details of the product's Electronic Product Code presented with an item return, without a receipt, together with a resulting displayed predictive purchase date range and associated confidence level, reflected as statistical percentage confidence level.

### DETAILED DESCRIPTION OF THE DRAWINGS

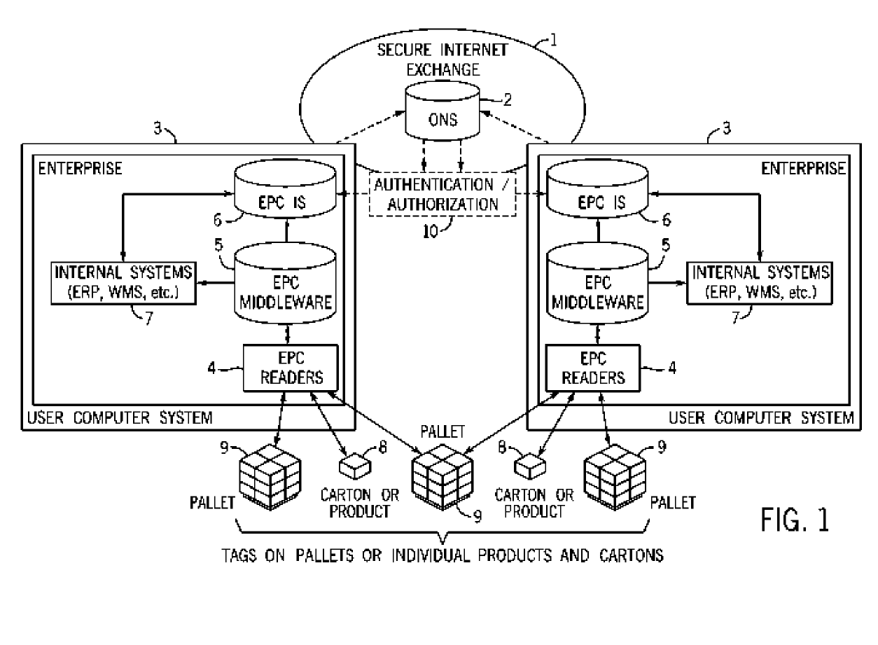

Referring initially to FIG. 1, representing a diagram of the EPC Network System. The Secure Internet Exchange 1 collects data from EPC/RIFD readers. The reader then passes the number to a computer or local application system 2, known as the Object Name Service (ONS). ONS tells the computer systems where to locate information on the network about the object carrying an EPC/RFID, such as when the item was produced. Physical Markup Language (PML) is used as a common language in the EPCglobal Network to define data on physical objects stored by an Enterprise 3 that maintains its own connections to EPC readers 4, EPC Middleware 5, EPC IS 6 and Internal Systems 7, such as ERP, WMS and sales register terminals. EPC readers 4 act as sensors within the EPC Network to record date and location events to the ONS 1 to report on operating parameters of Product 8 or Carton 8 or Pallet 9 activity reported to the ONS within the EPC Network. The EPC Network provides Authentication/Authorization protocols 10 to permit sharing of data between Enterprise 3 and users of the EPC Network.

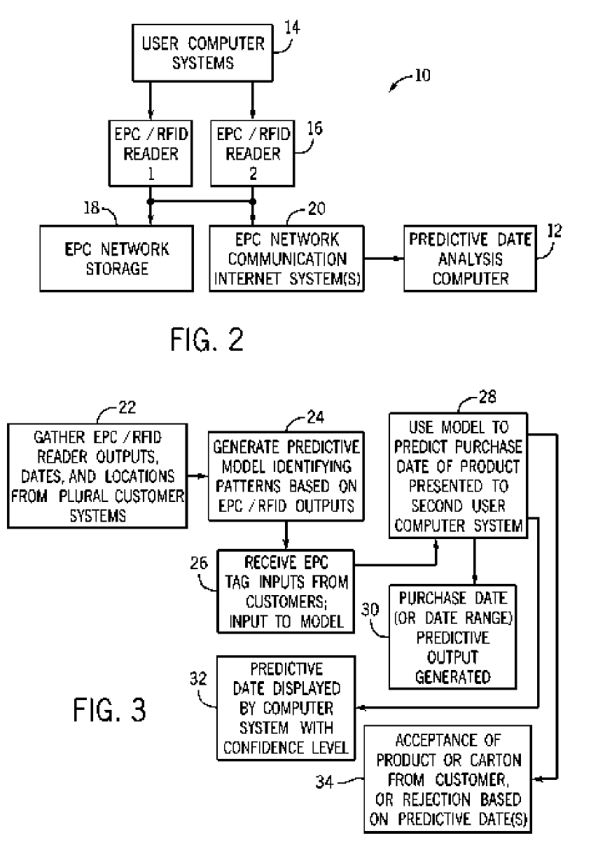

Referring initially to FIG. 2, a computing system is shown, generally designated 10, that includes one or more analysis computers 12 (only a single computer 12 shown for clarity) that undertakes the modeling set forth further below based on input from plural user computers 14 (only a single customer computer shown for clarity). The computers herein can be any suitable computers, e.g., a personal computer or larger (mainframe), a laptop computer, or a point-of-sale computer or sale authorization terminal. A service provider can provide the analysis computer 12 or it can be provided to a customer with several individual user computers 14 such as a product repair, return or exchange center. The below-described functions of the analysis computer 12 can be distributed between a vendor server and a customer server if desired.

As shown in FIG. 2, each user computer 14 may include plural RFID readers 16 that sense operating parameters of the user computer 14 and link them by database to the EPCglobal Network. These operating parameters can include date and location operating parameters within the user computer 14 components and/or facility. The operating parameters can also include shipping data, such as when a group of products (i.e., packed together in a shipment pallet) of one or more system components or related components (e.g., a comparable or alternate brand or model product of a type similar to the first operating group) was received by a warehouse, placed onto a retail store sales shelf, sold or shipped to a customer.

The user computer 14 may also include storage 18 for storing the outputs of the EPC/RFID reader(s) 16. Also, the user computer 14 can include a communication system 20 such as, without limitation, a modem that can communicate over a network such as the Internet with the analysis computer 12. With this structure, it may be appreciated that the operating parameter data output by the RFID reader(s) 16 can be stored in the storage 18 for retrieval by personnel associated with the analysis computer 12, and/or it can be sent to the analysis computer 12 over the Internet.

Now referring to FIG. 3, commencing at block 22, if desired customers (users) of computers can be given the option of predictive purchase date evaluation for participating in data gathering. At block 24, data is collected from all users or, when RFID data reading and associated records are reported and stored in the EPCglobal Network are offered at block 22, from just those who agreed to data gathering. This data includes the operating data from the RFID readers 16 of preferably plural user computers 14. Also, information regarding purchase location or event read location, if any, in the computers 14 that generate the EPC/RFID data that is recorded to the EPCglobal Network. For instance, placement date on retail store shelf and associated average turnover period (i.e., The average turnover period for a digital camera is 12 days, once such items are placed onto the selling floor shelf at Wal-mart stores) may be noted. If desired, the operating data and associated RFID event read and location date information can be encoded and encrypted for transmission to the analysis computer 12 over the Internet. Or, the information can be prepared for transmission by a store reporting or LAN subsystem using EPCglobal data sharing and protection systems or other schema for security. The information from the user computers may be pushed by the user computers automatically at, e.g., predetermined intervals to the analysis computer 12, or the analysis computer 12 can poll the user computers for their information, which they then send to the analysis computer 12.

Moving to block 24, the operating data and associated historical purchase date and trend pattern information is correlated and used to generate a predictive model for outputting predictions of purchase date. More specifically, a purchase date of a particular product or product grouping data (i.e., date and location related trends associated with Sharp brand microwave ovens) stored in computer system 14 is associated with the relevant operating data from that computer system. When more than one type of the same class or similar products (i.e., microwave ovens) exists a predictive model can be developed for each.

The predictive model can be generated using modeling principles known in the art. For example, regression analysis can be used to identify a particular operating parameter value that is correlated with the purchase date and location event(s). The analysis to generate the model can be done manually or using neural networks that employ model generation algorithms. In one example, it might happen that a brand of video game systems was known to be very popular for gift giving and that the inventory moved out of the store within hours of receiving the merchandise (i.e., Xbox 360 product in 2005). The resulting model in such a circumstance would be to generate a prediction of estimated sales date based on the same day, or within two days, from receipt of product into the store or online retail merchant's selling location(s). The examples above are of course illustrative only of various predictive models that can be generated, depending on the facts particular to each system and operating parameter.

Once the predictive models have been generated, additional operating data from customer computer systems can be received at block 26 and input to the model or models. At block 28, the predictive models analyze the data gathered at block 26 to better estimate, predict and report the product purchase date.

Proceeding to block 30, when a prediction of a purchase date or purchase date range is output by a prediction model, the necessary return acceptance decision-making can be accomplished by a an in-store customer service representative or other repair, return or exchange location with access to the system 32. Also, the retail store or merchandise location can determine the likelihood of customer purchase date from the store location and associated purchase date period at block 32 as appropriate for returns without a printed store purchase receipt or electronic local store data look up record based on the predictions from the models. Additionally, at block 34 customer service and support strategies can be established or updated based on the predictions of purchase date from the predictive models. For example, if a prediction exists that a presented product was purchased within a reasonably current period, the store associate may choose to accept the item for return or exchange. As another example, a product may be brought or sent to an authorized manufacturer service center (i.e., Sharp microwave convection oven) and the predictive purchase date system data at block 32 can help determine if such product should be repaired for free under an existing customer service policy that is associated with purchase date and location data, such as if product was purchased in the United States of America.

In one non-limiting implementation, the operating parameters can be stored as computer system inputs 26 and 28 as respectively shown in FIG. 2 for per user system and per customer usages. The non-limiting parameters stored in the tables 26 and 28 can include EPCglobal event data gathered from EPC/RFID reader devices located in trucks, warehouses, stores, and manufacturers to supply relevant warehouse data, transportation shipping data, location data and actual sales data to be applied to generate the predictive date(s).

The parameters received are weighted using the historical data derived at block 30. In non-limiting implementations each parameter is weighted according to its relevancy, and the resulting weights are multiplied and/or otherwise aggregated together to arrive at average purchase date data. The total weight can be correlated to a confidence level, e.g., a percentile confidence level that might yield an “excellent” confidence range or a “95% confidence level” rating associated with the predictive purchase date. These confidence scores are established for each individual product date estimation being reported at block 32 so a customer representative view the summary indication(s) and take the associated discretionary action for product or carton return acceptance, in part, based on the associated and reported date(s) confidence levels.

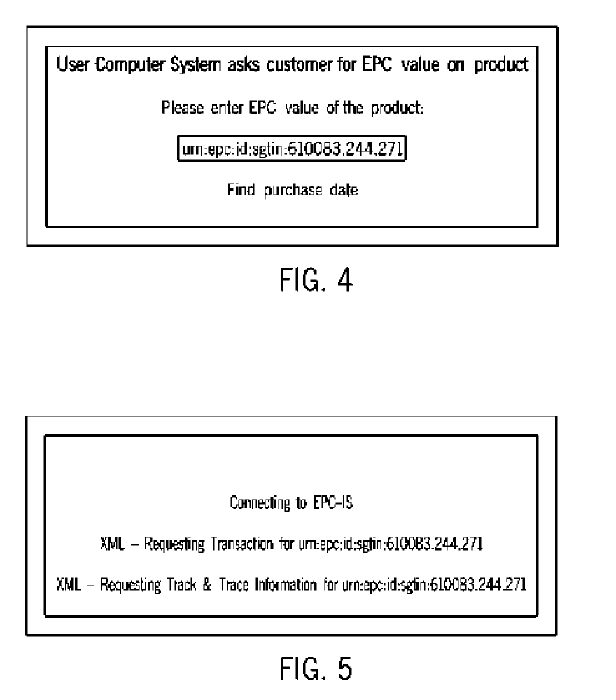

FIG. 4 is an Internet-connected Web screen interface example where a customer service representative enters the EPC value of a specific product by automated reading through an EPC/RFID reader and/or by manually entering the EPC value in an Internet connected web browser screen, represented as “urn:epc:id:sgtin:610083.244.271”) to enter a post-purchase item or carton's unique EPC number.

FIG. 5 is an Internet-connected Web screen interface example showing a user computer system connecting to the EPC-IS of the EPCglobal Network to request XML transaction and track and trace data from the EPC-IS using the EPC identifier represented by “urn:epc:id:sgtin:610083.244.271”.

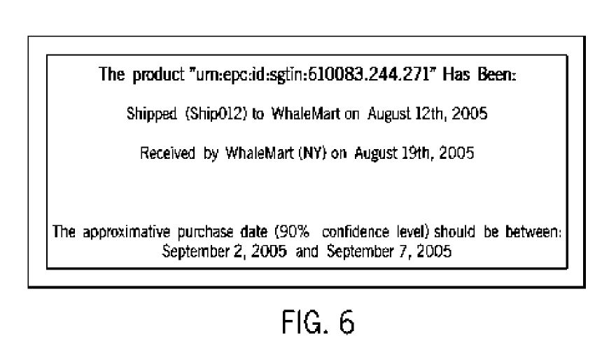

FIG. 6 is an Internet-connected Web screen interface displaying the results of FIG. 3, block 32, that presents an estimated purchase date(s) of Sep. 2, 2005 and Sep. 7, 2005, together with a 90% Confidence Level associated with the approximate purchase date range that is reported by the system through an Internet connection and browser display screen, or compatible browser based device.

While the particular system and method for predicting purchase date as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.”

What is claimed is:

1. A computerized system and method for establishing consumer purchase date for a specific product or its packaging carton based on operating parameters recorded in the Electronic Product Code Network (“EPC Network”); whenever an item-specific printed sales purchase receipt, or electronic local transaction purchase database date verification record, is unavailable for physical presentation by a customer or computerized look up at a retail store, repair service or product exchange location.

2. The method of claim 1 comprising: receiving data from plural first user computer systems, the data representing at least one operating date and physical location data event parameter of at least a portion of the first user computer systems; using the information regarding the date and location data of the first user computer systems, establishing at least one predictive model; receiving data from at least one second user computer system; and using a predictive model to generate a purchase date range prediction parameter, based on the data there from.

3. The method of claim 2, comprising a method performed by a computer system that tracks items in the supply chain from their manufacture to retail sale to end customers; the method comprising: receiving from one or more EPC tag reading events relating to one or more EPC tagged items, each event including a unique RFID tag identifier for a tag attached to an a product, carton or pallet; each event being an event that was recorded to the event database of the Electronic Product Code (“EPC”) Network.

4. The method of claim 2, comprising receiving post purchase from a customer, at least one return product for the second user computer system to initiate a purchase dates queries.

5. The method of claim 2, comprising establishing at least one sales activity event related to the first user computer system based at least in part on the prediction.

6. The method of claim 2, wherein the operating parameter is selected from the group of date and location event parameters consisting of: date of product manufacturer, manufacturer shipping dates, transportation dates, retail store or distributor sales dates, warehouse receiving dates, inventory turn-over data, on-shelf placement dates, sales location and source data with specific retail store, catalog or online website address.

7. The method of claim 2, comprising providing at least one of: the predictive model, and the prediction, to at least one user as a service.

8. The method of claim 2, comprising establishing purchase date estimation range for at least one user based at least in part on the user agreeing to provide data representing at least one operating parameter.

9. A general purpose computer system executing logic comprising: receiving first data representing at least one computer system operating parameter and associated computer system event date and location; generating at least one predictive model based on the first data; receiving second data representing at least one computer system operating parameter; inputting the second data to the predictive model; and executing the predictive model to generate at least one prediction of a purchase date, or purchase date estimate range, and an associated confidence percentile level reported together with the predictive estimate date(s); whenever an item-specific printed sales purchase receipt, or electronic local transaction purchase database date verification record, is unavailable for physical presentation by a customer or computerized look up at a retail store, repair or product exchange location.

10. The system of claim 9, wherein the operating parameter is selected from the group of parameters consisting of: date of product manufacturer, manufacturer shipping dates, transportation dates, retail store or distributor sales dates, warehouse receiving dates, inventory turn-over data, on-shelf placement dates and, in-store sales data associating a specific product or group of related products.

11. The system of claim 10, wherein the operating parameter is received over the Internet.

12. A general purpose computer system comprising: means for receiving first data representing at least one computer system operating parameter and associated computer system date and event data; means for generating at least one predictive model based on the first data; means for receiving second data representing at least one computer system operating parameter to read the EPC tag identifier associated with a purchased product, carton or pallet; means for inputting the second data to the predictive model; and means for executing the predictive model to generate at least one prediction of purchase date; whenever an item-specific printed sales purchase receipt, or electronic local transaction purchase database date verification record, is unavailable for physical presentation by a customer or computerized look up at a retail store, repair or product exchange location.

13. The method of claim 12, wherein the EPC tag identifier is a radio-frequency identification (“RFID”) tag or label affixed to a product, carton or pallet.

14. A service, comprising: providing a prediction of a purchase date for a product that has operating parameters recorded in a first computer system component associated with a first user based at least in part on correlating operating parameters composed of date and RFID reader event location event data from plural user computer systems with at least one operating parameter of the first computer system component.

15. The service of claim 14 comprising accepting for return at a retail store or post-purchase customer service location at least one purchased product associated with the first computer system based, at least in part, on the prediction.

16. The service of claim 14, comprising establishing at least one sales activity related to the first computer system component, based at least in part, on the prediction.

17. The service of claim 14, wherein the operating parameter is selected from the group of parameters consisting of: date of product manufacturer, manufacturer shipping dates, transportation dates, retail store or distributor sales dates, warehouse receiving dates, inventory turn-over data, on-shelf placement dates and, in-store sales data associating a specific product or group of related products.

18. The service of claim 14, comprising providing at least one of: the predictive model, and the prediction, reported to a second user computer system.

19. A service, comprising: generating a prediction of a purchase date of at least a first computer system component associated with a first user based at least in part on correlating operating parameters and date and ERPC/RFID reader event location data from plural user computer systems with at least one operating parameter of the first computer system component; and providing at least one service to the first user selected from the group of services consisting of: accepting for return at least one purchased product based at least in part on the prediction; and establishing at least one sales activity related to the first computer system component based at least in part on the prediction; whenever an item-specific printed sales purchase receipt, or electronic local transaction purchase database date verification record, is unavailable for physical presentation by a customer or computerized look up at a retail store, repair or product exchange location.

20. The service of claims 14-19 wherein the system, comprises: a reporting system including one or more EPC tag readers; one or more subscribers, including a system that tracks tagged items; and one or more event date records, the event dates being separate from the reporting system, wherein: the reporting system is operable to; detect one or more of the tagged items; generate an event, the event including a tag identifier, a reader location identifier, and a read date; and publish the event to one or more of the event records; the system for tracking tagged items is operable to: subscribe to receive data from one or more of the event date reading events relating to one or more of the tagged items; and upon receiving events, apply the received events to predicatively estimate information for one or more of the tagged items; and each event date is operable to: predict the purchase date; receive events from the reporting system; and report the estimated purchase date with an associated statistical percentile confidence level to an end user through a computer display screen or computerized message reporting system using the Internet to report results by computerized means, including but not limited to, in-store sales authorization and point-of-purchase cash register terminal devices.
